(19) United States
(12) Patent Application Publication
(10) Pub. No.: US 2026/0253251 A1
(43) Pub. Date: Aug. 27, 2026

(54) DETERMINATION METHOD, DETERMINATION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventor: Yuki MORI, Azumino-shi (JP)

(73) Assignee: SEIKO EPSON CORPORATION, Tokyo (JP)

(21) Appl. No.: 19/548,116

(22) Filed: Feb. 24, 2026

(30) Foreign Application Priority Data
Feb. 25, 2025 (JP) 2025-027638

(51) Int. Cl. G06T 7/73; H04N 9/31

(52) U.S. Cl. CPC G06T 7/73; H04N 9/3185

(57) ABSTRACT

An information processing apparatus functioning as a determination apparatus of the present disclosure includes a projection controller, an imaging controller, a detector, and a determination unit. The projection controller causes a projection apparatus to project, on a projection surface, a first pattern image including a plurality of first figures arranged in a matrix. The imaging controller acquires a first captured image of the first pattern image by a camera. The detector detects a second pattern image including a plurality of second figures corresponding one-to-one to the plurality of first figures based on the first captured image. The determination unit determines whether the detection of the first pattern image failed based on the number of figures belonging to an internal pattern out of the plurality of second figures.

The present application is based on, and claims priority from JP Application Serial Number 2025-027638, filed February 25, 2025, the disclosure of which is hereby incorporated by reference herein in its entirety.

### BACKGROUND

### 1. Technical Field

The present disclosure relates to a determination method, a determination apparatus, and a non-transitory computer-readable storage medium storing a program.

### 2. Related Art

A wall surface of a room of a house often has fine recesses or projections, and is not necessarily flat. When an image is projected from a projector using such a wall surface having fine recesses or projections as a projection surface, distortion according to the recess or projection of the wall surface may occur in the image displayed on the wall surface in some cases. In order to avoid an occurrence of such distortion, a correction function of projecting a pattern image such as a dot pattern from the projector onto the projection surface, detecting an image corresponding to the pattern image from a captured image obtained by capturing the pattern image displayed on the projection surface with a camera, and performing geometric correction or the like for canceling out the distortion on the projection image may be implemented in the projector in some cases. The dot pattern is a pattern in which dot figures(dot images) are arranged in, for example, a matrix.

Various methods for detecting the pattern image projected from the projector onto the projection surface have been proposed in the past, and an example thereof includes a method disclosed in JP-A-2024-18681. In the detection method disclosed in JP-A-2024-18681, first, a pattern image (hereinafter referred to as a projection pattern image) is displayed on the projection surface by projecting image light from the projector, and the captured image is acquired by a camera capturing the projection pattern image displayed on the projection surface. Subsequently, processing of detecting a pattern image (hereinafter referred to as a display pattern image) corresponding to the projection pattern image from the captured image is executed. In the detection method disclosed in JP-A-2024-18681, when 90% or more of the plurality of dot figures in the display pattern image are successfully detected, it is determined that the display pattern image is successfully detected. When the display pattern image fails to be detected, the display pattern image is detected from an image obtained by performing correction processing for increasing the possibility that the display pattern image is successfully detected on the captured image.

JP-A-2024-18681 is an example of the related art.

When the dot pattern image is used as the projection pattern image, as a factor of a failure in the detection of the dot figure, there can be cited the fact that, for example, the dot figure contained in the projection pattern image overlaps a frame of the projection surface. When the dot pattern image is used as the projection pattern image and the projection surface has a frame, in the technique disclosed in JP-A-2024-18681, when the number of dot figures that have been successfully detected is less than 90 % of the total number of dot figures on the grounds that the dot figures in the projection pattern image overlap the frame of the projection surface, it is determined that the detection of the display pattern image has failed. However, as long as the dot figures have successfully been detected in other portions than the peripheral portion in the display pattern image, distortion correction may successfully be performed in some cases even when the number of dot figures that have been successfully detected is less than 90 %. That is, the technique disclosed in JP-A-2024-18681 has a problem that a failure determination may be unnecessarily made in some cases.

### SUMMARY

An aspect of a determination method according to the present disclosure includes: acquiring a first captured image obtained by capturing, with a camera, a first pattern image which is projected from a projector onto a screen and which includes a plurality of first figures arranged side by side in a first direction and a second direction different from the first direction; detecting, based on the first captured image, a second pattern image which corresponds to the first pattern image and which includes a plurality of second figures corresponding one-to-one to the plurality of first figures; and determining whether detection of the first pattern image failed based on a number of at least one fourth figure located at a position closer to a center of the second pattern image than at least one third figure out of the plurality of second figures.

Further, an aspect of a determination apparatus of the present disclosure includes: a communication apparatus configured to communicate with a projector; and a processing apparatus, wherein the processing apparatus is configured to execute acquiring a first captured image obtained by capturing, with a camera, a first pattern image which is projected from the projector onto a screen and which includes a plurality of first figures arranged side by side in a first direction and a second direction different from the first direction, detecting, based on the first captured image, a second pattern image which corresponds to the first pattern image and which includes a plurality of second figures corresponding one-to-one to the plurality of first figures, and determining whether detection of the first pattern image failed based on a number of at least one fourth figure located at a position closer to a center of the second pattern image than at least one third figure out of the plurality of second figures.

An aspect of a non-transitory computer-readable storage medium storing a program of the present disclosure causes a computer to execute processing including: acquiring a first captured image obtained by capturing, with a camera, a first pattern image which is projected from a projector onto a screen and which includes a plurality of first figures arranged side by side in a first direction and a second direction different from the first direction; detecting, based on the first captured image, a second pattern image which corresponds to the first pattern image and which includes a plurality of second figures corresponding one-to-one to the plurality of first figures; and determining whether detection of the first pattern image failed based on a number of at least one fourth figure located at a position closer to a center of the second pattern image than at least one third figure out of the plurality of second figures.

### BRIEF DESCRIPTION OF THE DRAWINGS

FIG. 1 is a diagram showing a configuration example of a projection system 1 including an information processing apparatus 10 according to an embodiment of a determination apparatus of the present disclosure.

FIG. 2 is a diagram showing an example of a projection surface SC in a state in which an image GA is projected thereon from a projection apparatus 20.

FIG. 3 is a diagram showing an example of a pattern image PT1 to be projected on a projection surface SC from the projection apparatus 20.

FIG. 4 is a diagram showing a configuration example of the information processing apparatus 10.

FIG. 5 is a diagram showing a classification example of dot figures in the present embodiment.

FIG. 6 is a flowchart illustrating a flow of processing in a determination method executed by a processing device 140 in accordance with a program PR1.

FIG. 7 is a diagram illustrating pattern images PT2, PT3, and PT4 of Modified Example (1).

### DESCRIPTION OF EMBODIMENTS

Various technically preferable limitations are added to an embodiment described below. However, the embodiment of the present disclosure is not limited to an aspect described below.

### A. Embodiment

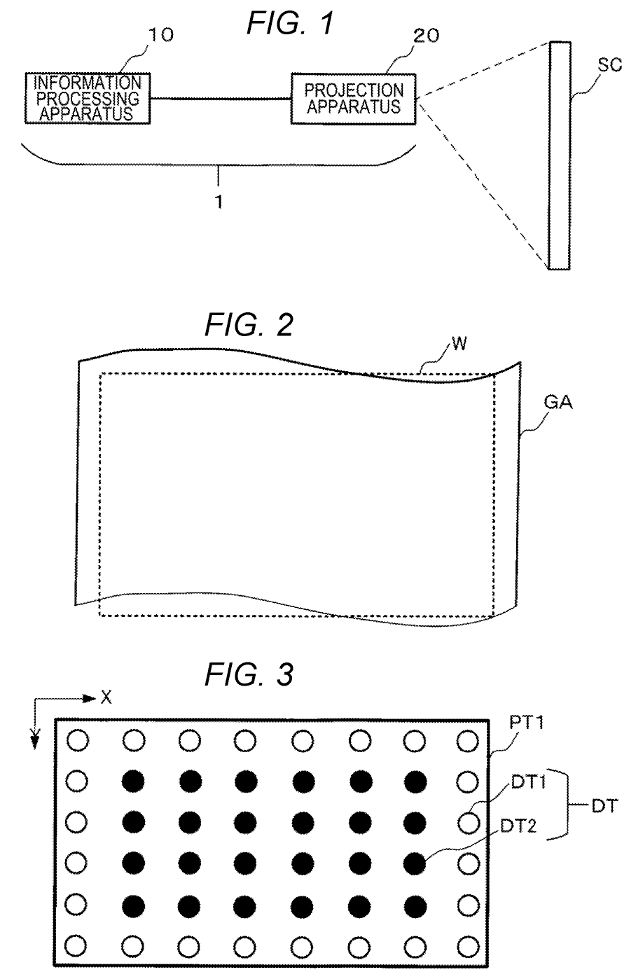

FIG. 1 is a diagram illustrating a configuration example of a projection system 1 including an information processing apparatus 10 according to an embodiment of a determination apparatus of the present disclosure. As shown in FIG. 1, the projection system 1 includes a projection apparatus 20 such as a projector in addition to the information processing apparatus 10. The projection apparatus 20 includes a display panel on which an image is drawn, and an optical system that guides, to a projection surface SC, image light emitted from the display panel. In FIG. 1, the display panel and the optical system are not illustrated. The projection apparatus 20 displays an image on the projection surface SC by projecting the image light on the projection surface SC under the control of the information processing apparatus 10. In the present embodiment, the projection surface SC is provided to a wall surface of a room in which the projection apparatus 20 is installed. The projection surface SC is an example of a screen in the present disclosure.

The wall surface of the room in which the projection apparatus 20 is installed has fine recesses or protrusions. Therefore, even when a contour of the image to be projected from the projection apparatus 20 onto the projection surface SC has a rectangular shape, as shown in FIG. 2, distortion according to the fine recesses or projections of the wall surface provided with the projection surface SC occurs in an image GA displayed on the projection surface SC by projecting the image light from the projection apparatus 20. Note that in FIG. 2, the reference symbol W denotes a frame that defines the projection surface SC.

The projection apparatus 20 is provided with a correction function for correcting the distortion generated in the display image in accordance with the fine recesses or projections of the projection surface SC. The projection apparatus 20 displays a pattern image PT1 shown in FIG. 3 on the projection surface SC under the control of the information processing apparatus 10. As shown in FIG. 3, the pattern image PT1 in the present embodiment is a dot pattern image including a plurality of dot figures DT arranged in a matrix in an X direction and a Y direction different from the X direction. In the present embodiment, the X direction is a direction corresponding to a horizontal scanning direction of the display panel in the projection apparatus 20, and the Y direction is a direction corresponding to a vertical scanning direction of the display panel in the projection apparatus 20. The pattern image PT1 is an example of a first pattern image in the present disclosure. The X direction is an example of a first direction in the present disclosure, and the Y direction is an example of a second direction in the present disclosure. The dot figure DT is an example of a first figure in the present disclosure.

Hereinafter, the plurality of dot figures DT arranged side by side in the X direction and the Y direction different from the X direction in the pattern image PT1 is classified into a dot figure DT1 belonging to an outer peripheral pattern and a dot figure DT2 belonging to an internal pattern. In FIG. 3, the dot figure DT1 belonging to the outer peripheral pattern is indicated by an open circle, and the dot figure DT2 belonging to the internal pattern is indicated by a black-filled circle. As illustrated in FIG. 3, the outer peripheral pattern refers to a set of dot figures arranged in N (N is an integer no smaller than 1) lines in the X direction and the Y direction along an outer circumference of a matrix configured with a plurality of dot figures. Although N=1 is assumed in the present embodiment, N may be 2, or may be 3 or more. As shown in FIG. 3, the outer peripheral pattern is annularly arranged along the outer circumference of the pattern image PT1. The dot figure DT1 belonging to the outer peripheral pattern is an example of a third figure in the present disclosure. The internal pattern refers to a set of dot figures arranged inside the outer peripheral pattern (i.e., at positions closer to the center of the pattern image PT1 than the dot figures belonging to the outer peripheral pattern). The dot figure DT2 belonging to the internal pattern is an example of a fourth figure in the present disclosure. Since the internal pattern is located at an inner side of the outer peripheral pattern, the fourth figure is located at a position closer to the center of the pattern image PT1 than at least one of the third figures.

In the present embodiment, various correction parameters for correcting the distortion described above are determined by the information processing apparatus 10 based on the captured image obtained by capturing the pattern image PT1 displayed on the projection surface SC by the camera, and the correction parameters thus determined are set in the projection apparatus 20 by the information processing apparatus 10.

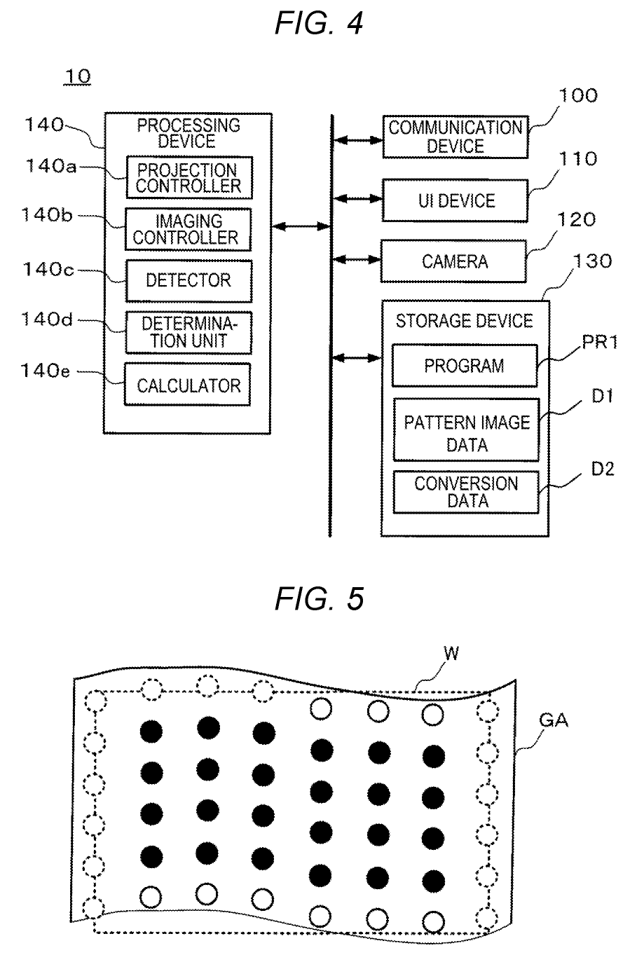

The information processing apparatus 10 is a smartphone that communicates with the projection apparatus 20 via, for example, a wireless local area network (LAN). FIG. 4 is a diagram showing a configuration example of the information processing apparatus 10. As illustrated in FIG. 4, the information processing apparatus 10 includes a communication device 100, a user interface (UI) device 110, a camera 120, a storage device 130, and a processing device 140. Each of the communication device 100, the UI device 110, the camera 120, and the storage device 130 is coupled to the processing device 140 via a bus (not illustrated in FIG. 4). Note that the camera 120 may be a device (e.g., a camera coupled to the information processing apparatus 10 via a wireless LAN) separate from the information processing apparatus 10. The communication device 100 is an example of a communication apparatus. The processing device 140 is an example of processing apparatus.

The communication device 100 includes an antenna that transmits and receives signals related to wireless communication, and a communication interface circuit that encodes and decodes those signals. The communication device 100 delivers data received, via a wireless LAN or the like, from the projection apparatus 20 to the processing device 140, and transmits, to the projection apparatus 20, data provided from the processing device 140.

The UI device 110 includes an input device including a plurality of operators such as a numeric keypad, and a display device for displaying various images under the control of the processing device 140. Specific examples of the display device include a liquid crystal display. In FIG. 4, the input device and the display device are not illustrated. When an operation such as holding down any of the operators is performed on the input device provided to the UI device 110, the UI device 110 delivers data according to the operation content of the user to the processing device 140. Thus, the operation content of the user is transmitted to the processing device 140.

The processing device 140 includes one processor or a plurality of processors. The processor includes, for example, a central processing unit (CPU). The processing device 140 is an example of a computer in the present disclosure. Although described later in detail, the processing device 140 operates in accordance with the program PR1 stored in advance in the storage device 130 to thereby function as a control center of the information processing apparatus 10.

The camera 120 includes a CMOS (Complementary Metal-Oxide-Semiconductor) image sensor or a CCD (Charge Coupled Device) image sensor. In the present embodiment, the camera 120 images a capturing area under the control of the processing device 140. The camera 120 outputs image data representing the captured image to the processing device 140.

The storage device 130 includes a nonvolatile memory such as a flash read-only memory (ROM) and a volatile memory such as a random-access memory (RAM). The nonvolatile memory of the storage device 130 stores the program PR1 for causing the processing device 140 to function as the control center of the information processing apparatus 10, pattern image data D1 representing the pattern image PT1, and conversion data D2. The conversion data D2 is data for mutually converting a position on a captured image captured by the camera 120 and a position on an image to be projected by the projection apparatus 20. The volatile memory of the storage device 130 is used by the processing device 140 as a work area when executing the program PR1. When an operation of instructing the UI device 110 to execute the program PR1 is performed, the processing device 140 reads the program PR1 from the nonvolatile memory onto the volatile memory, and then starts executing the program PR1 read onto the volatile memory.

The processing device 140 in operation according to the program PR1 functions as a projection controller 140a, an imaging controller 140b, a detector 140c, a determination unit 140d, and a calculator 140e.

The projection controller 140a controls the projection apparatus 20 to project the pattern image PT1 on the projection surface SC. In the present embodiment, the projection controller 140a reads the pattern image data D1 from the storage device 130 and transmits the pattern image data D1 and a command that instructs the projection of an image represented by the pattern image data D1 to the projection apparatus 20 using the communication device 100 to thereby cause the projection apparatus 20 to project the pattern image PT1 on the projection surface SC.

The imaging controller 140b controls the camera 120 to thereby cause the camera 120 to image the projection surface SC on which the pattern image PT1 is displayed. For example, the imaging controller 140b displays, on the display device of the UI device 110, a message or the like that instructs the user to dispose the information processing apparatus 10 so that the entire projection surface SC is included in the capturing area of the camera 120 to perform an imaging operation. The user of the projection system 1 performs the imaging operation after adjusting the position and the posture of the information processing apparatus 10 with respect to the projection surface SC in accordance with that message. In response to the execution of the imaging operation, the imaging controller 140b causes the camera 120 to perform imaging to acquire, from the camera 120, the image data representing the image captured by the camera 120. Thus, the imaging controller 140b acquires the captured image data representing the captured image obtained by imaging the projection surface SC on which the pattern image PT1 is displayed. The captured image obtained by imaging the projection surface SC on which the pattern image PT1 is displayed is an example of a first captured image in the present disclosure.

The detector 140c analyzes the captured image data acquired by the imaging controller 140b to thereby detect a pattern image corresponding to the pattern image PT1 in the captured image represented by the captured image data. The method of detecting the pattern image by the detector 140c is the same as the method disclosed in JP-A-2024-18681. The pattern image corresponding to the pattern image PT1 in the captured image represented by the captured image data includes a plurality of dot figures corresponding one-to-one to the plurality of dot figures in the pattern image PT1. The pattern image corresponding to the pattern image PT1 in the captured image is an example of a second pattern image in the present disclosure. The dot figures in the second pattern image (the plurality of dot figures corresponding one-to-one to the plurality of dot figures in the pattern image PT1) are each an example of the second figure in the present disclosure.

The determination unit 140d determines whether the detection of the pattern image PT1 has failed based on the number of dot figures which belong to the internal pattern and the positions of which have been successfully detected out of the plurality of dot figures in the second pattern image. For example, when the number of dot figures which belong to the internal pattern and the positions of which have been successfully detected is equal to or larger than a threshold (e.g., (the total number)×0.9) determined in accordance with the total number of dot figures belonging to the internal pattern, the determination unit 140d determines that the pattern image PT1 has been successfully detected. Conversely, when the number of dot figures which belong to the internal pattern and the positions of which have been successfully detected is less than the threshold described above, the determination unit 140d determines that the detection of the pattern image PT1 has failed.

FIG. 5 is a diagram illustrating an example of classification based on a result of the position detection related to the plurality of dot figures in the second pattern image. In FIG. 5, a black-filled circle represents a dot figure belonging to the internal pattern, an open circle with a solid outline represents a dot figure which belongs to the outer peripheral pattern and the position of which has been successfully detected, and an open circle with a dotted outline represents a dot figure which belongs to the outer peripheral pattern and the position of which has failed to be detected. When the plurality of dot figures in the second pattern image is classified as illustrated in FIG. 5, the determination unit 140d determines whether the detection of the pattern image PT1 has failed based on the number of dot figures corresponding to the black-filled circles.

The calculator 140e calculates correction parameters for distortion correction for each of the positions of the first figures based on a position in the second pattern image of the dot figure which belongs to the internal pattern and the position of which has been successfully detected and a position in the pattern image PT1 of the dot figure (i.e., the first figure) in the pattern image PT1 corresponding to that dot figure. For example, for the dot figure which belongs to the internal pattern and the position of which has been successfully detected, the calculator 140e obtains the position on the second pattern image at which the dot figure is to be located, based on the position in the pattern image PT1 of the dot figure (that is, the first figure) in the pattern image PT1 corresponding to that dot figure and the conversion data D2. Subsequently, the calculator 140e obtains a difference (i.e., distortion) between that position and the position in the second pattern image actually captured, and then calculates correction parameters for canceling that distortion. Then, the calculator 140e transmits the correction parameters thus calculated to the projection apparatus 20 via the communication device 100 to thereby set the correction parameters in the projection apparatus 20. Note that when the determination unit 140d determines that the detection of the pattern image PT1 has failed, the processing device 140 displays, on the display device, for example, a message prompting the user to adjust the position of the projection apparatus 20 with respect to the projection surface SC and then project and capture the pattern image PT1 once again.

In addition, regarding the dot FIGURE(hereinafter referred to as a fifth figure) which belongs to the outer peripheral pattern and the position of which has failed to be detected, the calculator 140e may estimate the position of that fifth figure based on a positional relationship with a fourth figure which is located around that fifth figure and the position of which has been successfully detected to calculate the correction parameters based on the estimation result. Specifically, the calculator 140e calculates the difference described above for the fourth figure which is located around the fifth figure and the position of which has been successfully detected, and estimates the position on the second pattern image of the fifth figure based on that difference. According to the present aspect, since the position of the fifth figure is estimated based on the positional relationship with the fourth figure located around that fifth figure, the accuracy of the correction of the image in the projection apparatus 20 can be improved compared to when the correction is performed with the fifth figure missing. In addition, when there is a dot figure (hereinafter referred to as a sixth figure) in the outer peripheral pattern the position of which has been successfully detected and which is located outside the fifth figure, the calculator 140e may estimate the position of the fifth figure based on the sixth figure and the fourth figure. According to the present aspect, the estimation accuracy of the position of the fifth figure is improved compared to the aspect in which the position of the fifth figure is estimated based only on the positional relationship with the fourth figure located around the fifth figure. Note that the estimation of the position of the fifth figure is not limited to the procedure described above. For example, the calculator 140e calculates a transformation matrix that associates coordinate of each of the four fourth figures which are located around the fifth figure and the positions of which have been successfully detected in a coordinate system of the captured image with a coordinate of each of the four fourth figures in a coordinate system of the display panel based on the four fourth figures. Then, the calculator 140e may estimate the position of the fifth figure in the coordinate system of the captured image based on the transformation matrix and the coordinates of the fifth figure in the coordinate system of the display panel.

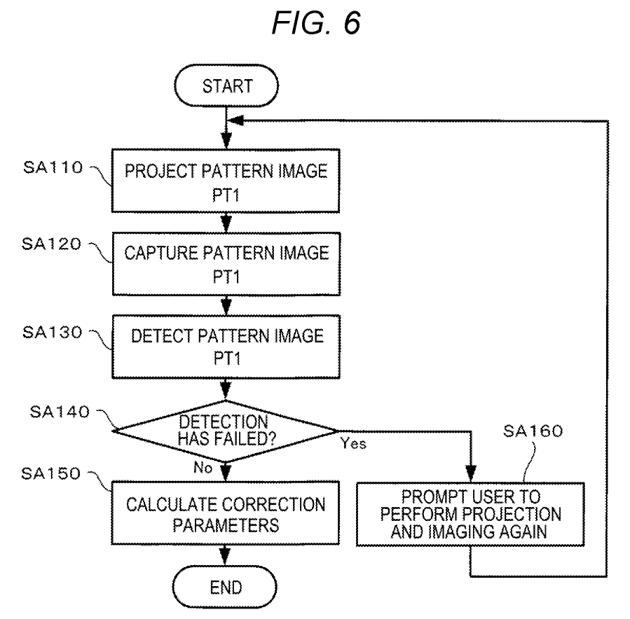

Further, the processing device 140 operating in accordance with the program PR1 executes a determination method that conspicuously shows features of the present disclosure. FIG. 6 is a flowchart illustrating a flow of processing in the determination method.

In step SA110, the processing device 140 functions as the projection controller 140a. In step SA110, the processing device 140 reads the image data representing the pattern image PT1 from the storage device 130, and then transmits the image data and the command for instructing the projection of the image represented by the image data to the projection apparatus 20 using the communication device 100 to thereby cause the projection apparatus 20 to project the pattern image PT1 on the projection surface SC. Note that step SA110 may be omitted. Specifically, instead of transmitting the command for projecting the pattern image PT1 on the projection surface SC from the processing device 140 to the projection apparatus 20, the pattern image PT1 may be projected on the projection surface SC in accordance with a user operation on the projection apparatus 20 independent of the control by the processing device 140. The user operation on the projection apparatus 20 is, for example, an operation on an operation button of the projection apparatus 20 (not illustrated) or an operation on a menu screen projected on the projection surface SC by the projection apparatus 20. In this case, the image data representing the pattern image PT1 may be stored in a storage device provided to the projection apparatus 20 instead of the storage device 130.

In step SA120 executed subsequent to step SA110, the processing device 140 functions as the imaging controller 140b. In step SA120, the processing device 140 controls the camera 120 to thereby cause the camera 120 to image the projection surface SC on which the pattern image PT1 is displayed, and acquires the captured image data representing the captured image from the camera 120.

In step SA130 subsequent to step SA120, the processing device 140 functions as the detector 140c. In step SA130, the processing device 140 analyzes the captured image data acquired in step SA120 to thereby detect the pattern image corresponding to the pattern image PT1 in the captured image represented by the captured image data.

In step SA140 subsequent to step SA130, the processing device 140 functions as the determination unit 140d. Whether the detection of the pattern image PT1 has failed is determined based on the number of dot figures which belong to the internal pattern and the positions of which have been successfully detected out of the plurality of dot figures in the second pattern image. When the determination result in step SA140 is "No", that is, when it is determined that the pattern image PT1 has been successfully detected, the processing device 140 executes processing in step SA150. Conversely, when the determination result in step SA140 is "Yes", that is, when it is determined that the detection of the pattern image PT1 has failed, the processing device 140 executes processing in step SA160.

In step SA160, the processing device 140 displays, on the display device, the message prompting the user to adjust the position of the projection apparatus 20 with respect to the projection surface SC and then project and capture the pattern image PT1 once again. Subsequently, the processing device 140 executes the processing in step SA110 and subsequent steps once again. In contrast, in step SA150, the processing device 140 first calculates the correction parameters for distortion correction for each of the positions of the first figures based on the position in the second pattern image of the dot figure which belongs to the internal pattern and the position of which has been successfully detected and the position in the pattern image PT1 of the dot figure (i.e., the first figure) in the pattern image PT1 corresponding to that dot figure. Then, the processing device 140 transmits the correction parameters thus calculated to the projection apparatus 20 via the communication device 100 to thereby set the correction parameters in the projection apparatus 20.

As described above, according to the present embodiment, whether the detection of the pattern image PT1 has failed is determined based on the number of dot figures belonging to the internal pattern. There is a high possibility that the dot figure belonging to the outer peripheral pattern overlaps the frame of the projection surface SC, and when it is determined whether the detection of the pattern image PT1 has failed based on the number of dot figures including the dot figures belonging to the outer peripheral pattern, the failure determination is unnecessarily performed. According to the present embodiment, it is possible to avoid the unnecessary failure determination compared to an aspect in which it is determined whether the detection of the pattern image PT1 has failed based on the number of dot figures including the dot figures belonging to the outer peripheral pattern.

It is also conceivable to avoid the unnecessary failure determination by detecting the frame of the projection surface SC in advance by analyzing the captured image of the camera 120 prior to the detection of the pattern image PT1, and then determining the success or failure of the detection of the pattern image PT1 while excluding the dot figures overlapping the frame out of the dot figures belonging to the outer peripheral pattern. However, in the aspect in which the frame of the projection surface SC is detected prior to the detection of the pattern image PT1, the processing load increases compared to the present embodiment by the processing required for the detection of the frame, and the processing time until the success or failure of the detection of the pattern image PT1 is determined becomes longer than that in the present embodiment. That is, according to the present embodiment, it is possible to avoid unnecessary failure determination without incurring an increase in the processing time.

### B. Modifications

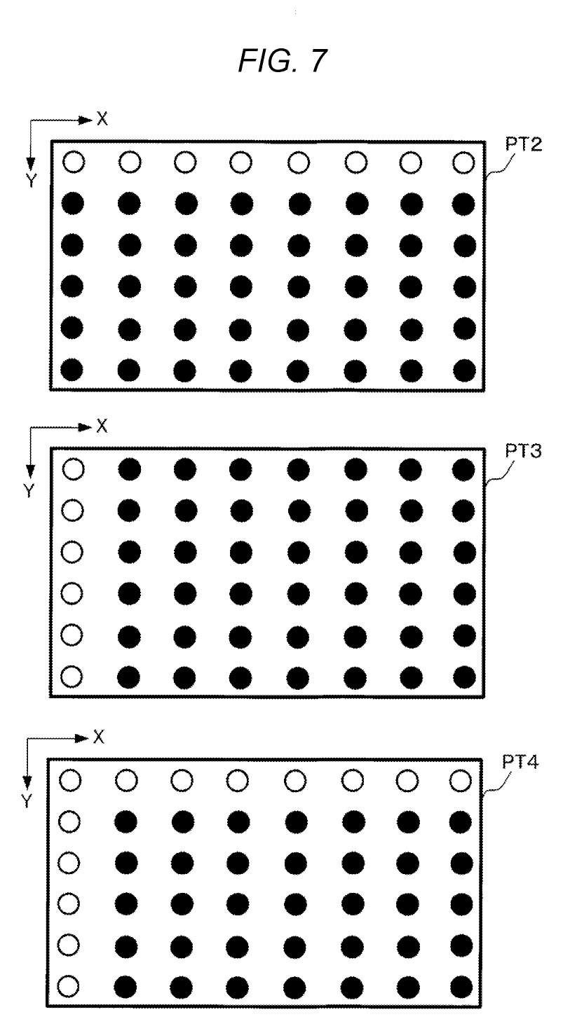

The embodiment described above can be modified as follows.
(1) In the embodiment described above, the first figures(i.e., the outer peripheral pattern) corresponding to the third figures in the first pattern image are annularly arranged along the outer circumference of the first pattern image. However, as in a pattern image PT2 illustrated in FIG. 7, the outer peripheral pattern may be disposed along one side in the X direction in the pattern image, or as in a pattern image PT3 illustrated in FIG. 7, the outer peripheral pattern may be disposed along one side in the Y direction in the pattern image. Further, as in a pattern image PT4 illustrated in FIG. 7, the outer peripheral pattern may be disposed in an L-shape along one side in the X direction and one side in the Y direction continuous with that one side in the pattern image. Further, the density of the dot figures may be the same between the internal pattern and the outer peripheral pattern, or the density of the dot figures may be different between the internal pattern and the outer peripheral pattern. Further, the density of the dot figures in the outer peripheral pattern is not required to be uniform in the outer peripheral pattern, and the density of the dot figures may become lower as the distance from the center of the pattern image increases. Note that in the above embodiment, the dot pattern is used as the pattern image PT1, but a pattern different from the dot pattern, such as a checker pattern may be used. Further, the pattern image PT1 may be a random dot pattern.
(2) In the embodiment described above, the processing device 140 of the information processing apparatus 10 that communicates with the projection apparatus 20 via the wireless LAN is made to execute the determination method of the present disclosure. However, a computer of the projection apparatus 20 may be made to execute the determination method of the present disclosure by installing the program PR1 in the projection apparatus 20, and making the computer of the projection apparatus 20 operate in accordance with that program PR1. In this case, the camera 120 may be provided to the projection apparatus 20 or may be connected to the projection apparatus 20 via a wireless LAN or the like.
(3) First processing of estimating the position of the fifth figure based on the positional relationship with the fourth figures located around the fifth figure and second processing of estimating the position of the fifth figure based on the sixth figure which is located farther than the fifth figure and the position of which has been successfully detected and the fourth figure may be executed in a switching manner in accordance with a condition. Specific examples of the condition for switching between the first processing and the second processing include a condition related to a processing load being applied to the processing device 140 (e.g., whether the processing load is equal to or greater than a predetermined threshold). Specifically, when the processing load applied to the processing device 140 is equal to or greater than the threshold, it is sufficient to cause the processing device 140 to execute the first processing, and when the processing load applied to the processing device 140 is less than the threshold, it is sufficient to cause the processing device 140 to execute the second processing. This is because the second processing is higher in processing load compared to the first processing, and an excessive load applied to the processing device 140 is avoided. Further, as another specific example of the condition described above, there is cited a condition related to an arithmetic performance of the processing device 140 (whether the arithmetic performance of the processing device 140 is equal to or higher than a predetermined threshold). Specifically, when the arithmetic performance of the processing device 140 is less than the threshold, it is sufficient to cause the processing device 140 to execute the first processing, and when the arithmetic performance of the processing device 140 is equal to or higher than the threshold, it is sufficient to cause the processing device 140 to execute the second processing. The arithmetic performance includes the number of cores and an operating frequency of the CPU. In addition, as another specific example of the condition described above, there is cited a setting by the user. Specifically, the information processing apparatus 10 receives an operation of selecting one of execution of the first processing and execution of the second processing, and switches between the first processing and the second processing in accordance with a result of the selection. According to this aspect, it is possible to avoid causing the processing device 140 to execute processing exceeding the arithmetic performance.
(4) In the embodiment described above, as an example of the reason why the failure determination is unnecessarily performed, there is cited when the possibility that the dot figure belonging to the outer peripheral pattern overlaps the frame of the projection surface SC is high. However, the event in which the failure determination is unnecessarily made may occur when the projection surface SC has no frame. For example, when the projection surface SC has a pattern, the failure determination may be unnecessarily made regarding a dot figure belonging to the outer peripheral pattern when overlapping the pattern of the projection surface SC. Therefore, the disclosure according to the embodiment described above can be applied not only when the projection surface SC has the frame.
(5) The projection controller 140a, the imaging controller 140b, the detector 140c, the determination unit 140d, and the calculator 140e in the embodiment described above are software modules. However, at least one of the projection controller 140a, the imaging controller 140b, the detector 140c, the determination unit 140d, and the calculator 140e may be a hardware module such as an application specific integrated circuit (ASIC). Even when at least one of the projection controller 140a, the imaging controller 140b, the detector 140c, the determination unit 140d, and the calculator 140e is the hardware module, the same advantages as those of the embodiment described above are achieved.
(6) The program PR1 may be manufactured alone, and may be provided for a fee or free of charge. Specific aspects when providing the program PR1 include an aspect in which the program PR1 is provided by being written in a computer-readable recording medium such as a flash ROM or an aspect in which the program PR1 is provided by being downloaded through an electric communication line such as the Internet.

### C. Summary of Present Disclosure

The present disclosure is not limited to the embodiment and the modifications described above and can be implemented in various aspects without departing from the gist of the present disclosure. For example, the present disclosure can also be implemented by the following aspects. Technical features in the embodiment described above corresponding to the technical features in the aspects described below can be replaced or combined as appropriate in order to solve some or all of the problems of the present disclosure or in order to achieve some or all of the advantages of the present disclosure. Further, the technical features thereof can be deleted as appropriate unless described as essential features in the present specification.

The present disclosure will be summarized below as appendices.

### Appendix 1

An aspect of a determination method according to the present disclosure includes: acquiring a first captured image obtained by capturing, with a camera, a first pattern image which is projected from a projector onto a screen and which includes a plurality of first figures arranged side by side in a first direction and a second direction different from the first direction; detecting, based on the first captured image, a second pattern image which corresponds to the first pattern image and which includes a plurality of second figures corresponding one-to-one to the plurality of first figures; and determining whether detection of the first pattern image failed based on a number of at least one fourth figure located at a position closer to a center of the second pattern image than at least one third figure out of the plurality of second figures. According to the determination method of the present aspect, since it is determined whether the detection of the first pattern image has failed based on the number of the fourth figures located at the positions closer to the center of the second pattern image than the at least one third figure, it is possible to avoid unnecessary failure determination compared to when it is determined whether the detection of the first pattern image has failed based on the number of the figures including the at least one third figure.

### Appendix 2

A determination method according to another aspect of the present disclosure is the determination method according to Appendix 1 further including estimating a position of a fifth figure which is located farther than the at least one fourth figure when viewed from the center of the second pattern image and a position of which failed to be detected out of the plurality of second figures based on a positional relationship with the fourth figure located around the fifth figure. According to the determination method of the present aspect, since the position of the fifth figure is estimated based on the positional relationship with the fourth figure located around that fifth figure, the accuracy of the correction of the image in the projector can be improved compared to when the correction is performed with the fifth figure missing.

### Appendix 3

A determination method of a more preferred aspect is the determination method according to Appendix 2 wherein the estimating the position of the fifth figure based on the positional relationship with the fourth figure located around the fifth figure includes estimating the position of the fifth figure based on the fourth figure and a sixth figure which is located farther than the fifth figure when viewed from the center of the second pattern image out of the plurality of second figures and a position of which has been successfully detected. According to the present aspect, the estimation accuracy of the position of the fifth figure is improved compared to the aspect in which the position of the fifth figure is estimated based only on the positional relationship with the fourth figure located around the fifth figure.

### Appendix 4

A determination method according to a further preferred aspect is the determination method according to Appendix 1 further including executing, in a switching manner according to a condition, first processing of estimating a position of a fifth figure which is located farther than the at least one fourth figure when viewed from the center of the second pattern image out of the plurality of second figures and the position of which failed to be detected based on a positional relationship with the fourth figure located around the fifth figure, and second processing of estimating the position of the fifth figure based on the fourth figure and a sixth figure which is located farther than the fifth figure when viewed from the center of the second pattern image out of the plurality of second figures and a position of which has been successfully detected. According to the present aspect, it is possible to optimize whether to execute the second processing.

### Appendix 5

A determination method according to a further preferred aspect is the determination method according to any one of Appendices 1 to 4 wherein in the first pattern image, the first figures corresponding to the third figures are annularly arranged along an outer circumference of the first pattern image.

### Appendix 6

An aspect of a determination apparatus of the present disclosure includes: a communication apparatus configured to communicate with a projector; and a processing apparatus, wherein the processing apparatus is configured to execute acquiring a first captured image obtained by capturing, with a camera, a first pattern image which is projected from the projector onto a screen and which includes a plurality of first figures arranged side by side in a first direction and a second direction different from the first direction, detecting, based on the first captured image, a second pattern image which corresponds to the first pattern image and which includes a plurality of second figures corresponding one-to-one to the plurality of first figures, and determining whether detection of the first pattern image failed based on a number of at least one fourth figure located at a position closer to a center of the second pattern image than at least one third figure out of the plurality of second figures. According to the determination apparatus of the present aspect, since it is determined whether the detection of the first pattern image has failed based on the number of the fourth figures located at the positions closer to the center of the second pattern image than the at least one third figure, it is possible to suppress unnecessary failure determination compared to when it is determined whether the detection of the first pattern image has failed based on the number of the figures including the at least one third figure.

### Appendix 7

An aspect of a non-transitory computer-readable storage medium storing a program of the present disclosure causes a computer to execute processing including: acquiring a first captured image obtained by capturing, with a camera, a first pattern image which is projected from a projector onto a screen and which includes a plurality of first figures arranged side by side in a first direction and a second direction different from the first direction; detecting, based on the first captured image, a second pattern image which corresponds to the first pattern image and which includes a plurality of second figures corresponding one-to-one to the plurality of first figures; and determining whether detection of the first pattern image failed based on a number of at least one fourth figure located at a position closer to a center of the second pattern image than at least one third figure out of the plurality of second figures. According to the non-transitory computer-readable storage medium storing the program of the present aspect, since it is determined whether the detection of the first pattern image has failed based on the number of the fourth figures located at the positions closer to the center of the second pattern image than the at least one third figure, it is possible to suppress unnecessary failure determination compared to when it is determined whether the detection of the first pattern image has failed based on the number of the figures including the at least one third figure.

What is claimed is:

1. A determination method comprising:
acquiring a first captured image obtained by capturing, with a camera, a first pattern image which is projected from a projector onto a screen and which includes a plurality of first figures arranged side by side in a first direction and a second direction different from the first direction;
detecting, based on the first captured image, a second pattern image which corresponds to the first pattern image and which includes a plurality of second figures corresponding one-to-one to the plurality of first figures; and
determining whether detection of the first pattern image failed based on a number of at least one fourth figure located at a position closer to a center of the second pattern image than at least one third figure out of the plurality of second figures.

2. The determination method according to claim 1, further comprising
estimating a position of a fifth figure which is located farther than the at least one fourth figure when viewed from the center of the second pattern image and a position of which failed to be detected out of the plurality of second figures based on a positional relationship with the fourth figure located around the fifth figure.

3. The determination method according to claim 2, wherein
the estimating the position of the fifth figure based on the positional relationship with the fourth figure located around the fifth figure includes estimating the position of the fifth figure based on the fourth figure and a sixth figure which is located farther than the fifth figure when viewed from the center of the second pattern image out of the plurality of second figures and a position of which has been successfully detected.

4. The determination method according to claim 1, further comprising
executing, in a switching manner according to a condition, first processing of estimating a position of a fifth figure which is located farther than the at least one fourth figure when viewed from the center of the second pattern image out of the plurality of second figures and the position of which failed to be detected based on a positional relationship with the fourth figure located around the fifth figure, and second processing of estimating the position of the fifth figure based on the fourth figure and a sixth figure which is located farther than the fifth figure when viewed from the center of the second pattern image out of the plurality of second figures and a position of which has been successfully detected.

5. The determination method according to claim 1, wherein
in the first pattern image, the first figures corresponding to the third figures are annularly arranged along an outer circumference of the first pattern image.

6. A determination apparatus comprising:
a communication apparatus configured to communicate with a projector; and
a processing apparatus, wherein
the processing apparatus is configured to execute
acquiring a first captured image obtained by capturing, with a camera, a first pattern image which is projected from the projector onto a screen and which includes a plurality of first figures arranged side by side in a first direction and a second direction different from the first direction,
detecting, based on the first captured image, a second pattern image which corresponds to the first pattern image and which includes a plurality of second figures corresponding one-to-one to the plurality of first figures, and
determining whether detection of the first pattern image failed based on a number of at least one fourth figure located at a position closer to a center of the second pattern image than at least one third figure out of the plurality of second figures.

7. A non-transitory computer-readable storage medium storing a program causing a computer to execute processing comprising:
acquiring a first captured image obtained by capturing, with a camera, a first pattern image which is projected from a projector onto a screen and which includes a plurality of first figures arranged side by side in a first direction and a second direction different from the first direction;
detecting, based on the first captured image, a second pattern image which corresponds to the first pattern image and which includes a plurality of second figures corresponding one-to-one to the plurality of first figures; and
determining whether detection of the first pattern image failed based on a number of at least one fourth figure located at a position closer to a center of the second pattern image than at least one third figure out of the plurality of second figures.
